(19) United States
(12) Patent Application Publication
(10) Pub. No.: US 2015/0257343 A1
(43) Pub. Date: Sep. 17, 2015

(54) Protective Horticultural Bag

(71) Applicants: Elizabete De Lima, Rehoboth, MA (US); Adam T. Lescault, Ashaway, RI (US)

(72) Inventors: Elizabete De Lima, Rehoboth, MA (US); Adam T. Lescault, Ashaway, RI (US)

(21) Appl. No.: 14/604,923

(22) Filed: Jan. 26, 2015

Related U.S. Application Data
(60) Provisional application No. 61/952,403, filed on Mar. 13, 2014.

(51) Int. Cl. A01G 13/00

(52) U.S. Cl. CPC A01G 13/0237

(57) ABSTRACT

A protective horticultural bag is an apparatus that is placed over a plant growing container in order to provide a physical barrier between the root ball of the plant within the container and the exterior environment. The protective horticultural bag features a tubular membrane that is stretchable in order to accommodate various designs of plant growing containers. An elastic cord is utilized to increase or decrease the size of an open end of the tubular membrane in order to allow the stem of the plant to extend through the open end as the plant grows. A cord clamp is utilized to fix the elastic cord in place on the tubular membrane when the size of the open end is as desired. The tubular membrane is breathable in order to allow liquid and air to pass through the tubular membrane while preventing insects and other pests from accessing the plant.

The current application claims a priority to the U.S. Provisional Patent application Ser. No. 61/952,403 filed on Mar. 13, 2014.

### FIELD OF THE INVENTION

The present invention relates generally to a cover for protecting plants from pests. More specifically, the present invention is a protective horticultural bag that protects a plant from pests while remaining breathable and allowing the plant to be watered with the protective horticultural bag placed over the root ball and/or any growing container.

### BACKGROUND OF THE INVENTION

In addition to growing plants directly in the ground, it is common practice to grow the plants in containers such as flowerpots. Container growing offers a number of advantages such as a decreased risk of soil-borne diseases and weed growth. Additionally, container growing allows for a greater degree of control over temperature, moisture, and sunlight provided to a plant. However, as with plants grown in the ground, plants grown in containers are susceptible to pests. A gardener may be forced to spray plants with pesticides and/or insecticides against his or her better judgment due to the more pressing need to eliminate destructive pests. It is possible to make use of a plant cover that is capable of shrouding a plant growing in a container in order to prevent pests from attacking the plant. However, these plant covers are generally not breathable and as a result, can hinder the growth of plants. Additionally, a plant cannot be watered while a plant cover is in place over the plant, forcing the plant cover to be removed prior to watering the plant and then subsequently replaced. Because of this, caring for a plant that is protected by a plant cover can quickly become a tedious, cumbersome affair.

The present invention is a protective horticultural bag that is utilized to protect a plant's root ball and indirectly protect the entire plant from insects and other pests. The present invention is primarily intended for use with a plant that is grown in a container and serves as a barrier between the plant's root ball and the surrounding environment while remaining breathable. The breathability of the present invention additionally allows the plant to be watered without having to remove the present invention from the plant. In addition to preventing harmful pests from damaging the plant, the present invention additionally prevents the growth of weeds and other invasive plant species in the soil within the growing container as well. The present invention is stretchable in order to allow the present invention to be used in conjunction with a wide variety of plant growing containers. In addition, the present invention has applications in hydroponic, aquaponic, and aeroponic growing systems as well.

### BRIEF DESCRIPTION OF THE DRAWINGS

FIG. 1 is a perspective view of the present invention.

FIG. 2 is an additional perspective view of the present invention.

FIG. 3 is a side view of the present invention.

FIG. 4 is a cross-sectional view of the present invention taken along line A-A of FIG. 3.

FIG. 5 is a side view of the plurality of pores traversing through the tubular membrane.

FIG. 6 is a perspective view of a plant being inserted into the present invention.

FIG. 7 is a perspective view of the plant inserted into and secured within the present invention.

### DETAIL DESCRIPTIONS OF THE INVENTION

All illustrations of the drawings are for the purpose of describing selected versions of the present invention and are not intended to limit the scope of the present invention.

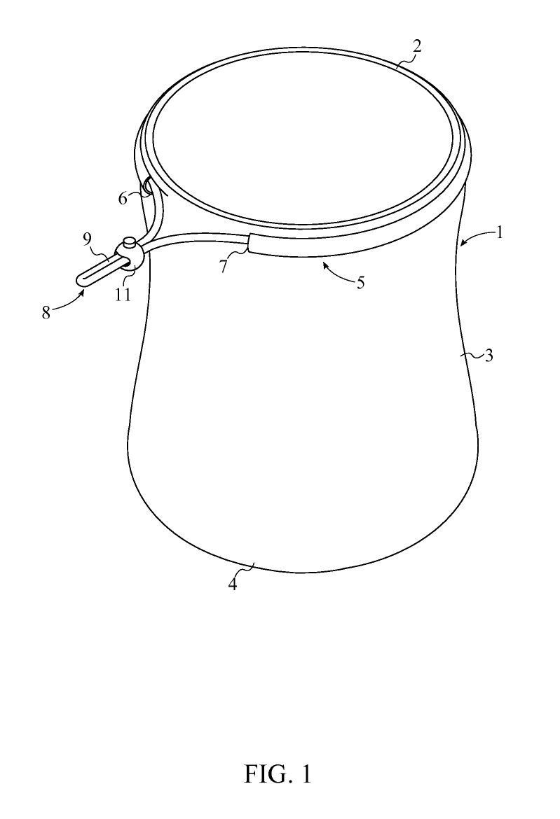

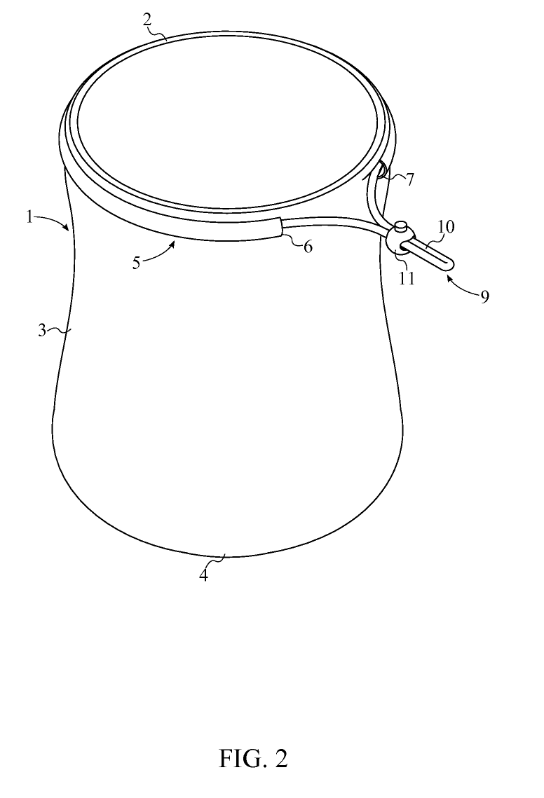

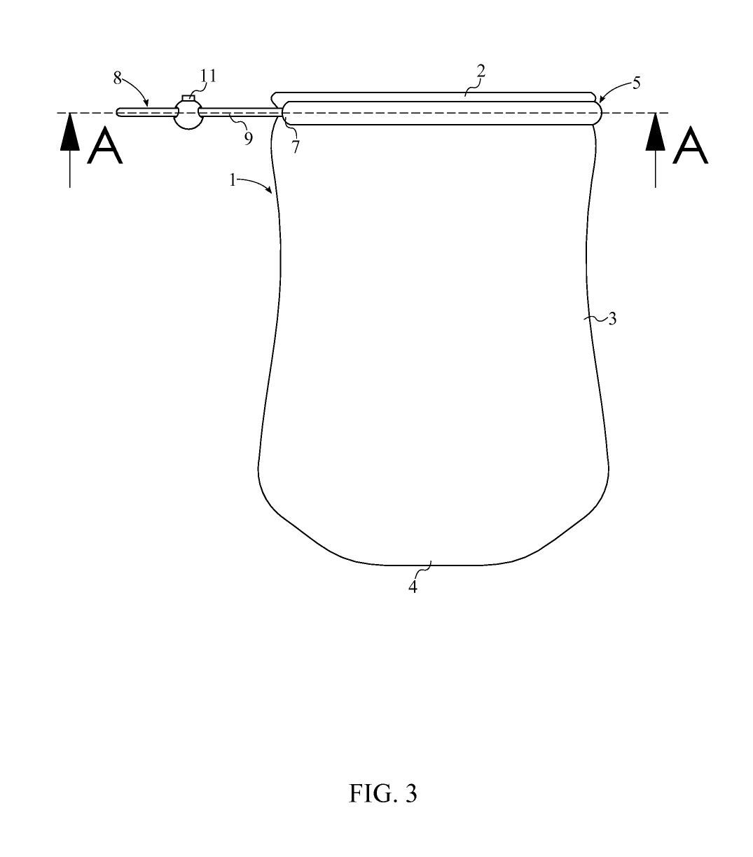

The present invention is a protective horticultural bag that is designed to serve as a barrier between a container-grown plant's root ball and the surrounding environment. The present invention provides protection from weeds, insects, and other pests that are harmful to the plant without hindering any of the natural biological functions of the plant. With reference to FIGS. 1-5, the present invention comprises a tubular membrane 1, a cord sheathe 5, an elastic cord 8, a cord clamp 11, and a plurality of pores 12.

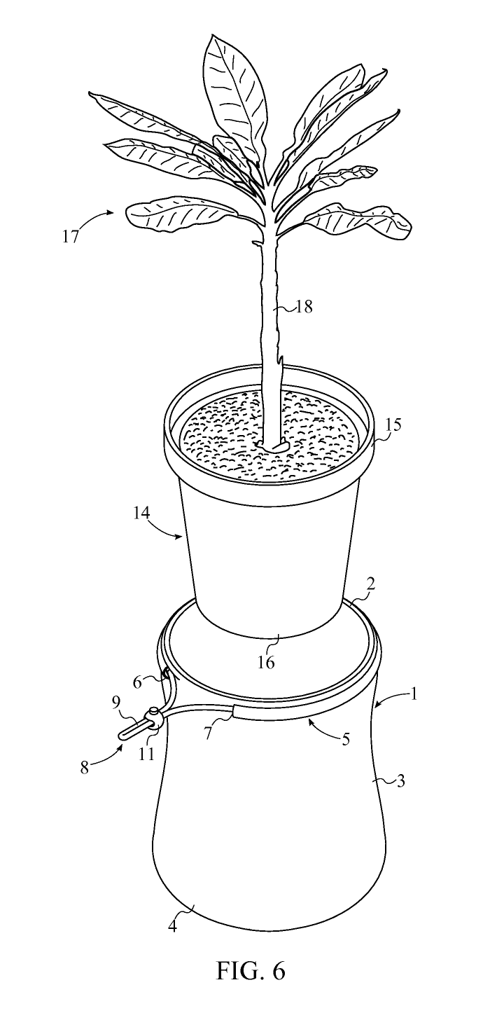

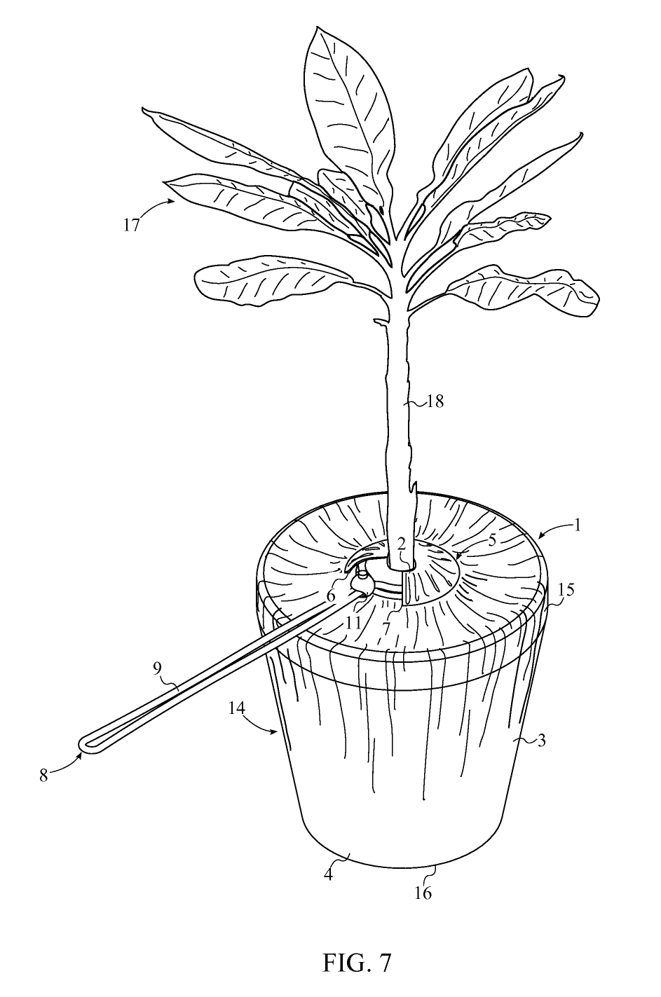

Again with reference to FIGS. 1-5 and with reference to FIG. 6 and FIG. 7, the tubular membrane 1 provides a physical barrier between the root ball of the plant 17 and the surrounding environment that is impermeable to insects attempting to harm the plant 17. In the preferred embodiment of the present invention, the tubular membrane 1 is made of a nylon and spandex blended material, allowing the tubular membrane 1 to be stretched in order to accommodate plant growing containers of various sizes. With reference to FIGS. 1-3, the tubular membrane 1 comprises an open end 2, a lateral portion 3, and a closed end 4. The size of the open end 2 is adjustable via the elastic cord 8 and the cord clamp 11 in order to allow the present invention to be used to cover the root balls of plants with stems of varying sizes. The lateral portion 3 is stretchable, allowing the tubular membrane 1 to be fitted to various sizes of plant growing containers as shown in FIG. 7. The closed end 4 serves as a base for the plant growing container 14 to which the tubular membrane 1 is secured.

Referring to FIGS. 1-3, the cord sheathe 5 houses the elastic cord 8 and prevents the elastic cord 8 from separating from the tubular membrane 1. The cord sheathe 5 comprises a first sheathe open end 6 and a second sheathe open end 7. The first sheathe open end 6 and the second sheathe open end 7 allow the elastic cord 8 to be grasped by the user when adjusting the size of the open end 2. The cord sheathe 5 is externally connected around the lateral portion 3, adjacent to the open end 2. This allows the elastic cord 8 to constrict or loosen the portion of the tubular membrane 1 around the open end 2 in order to increase or decrease the size of the open end 2 to accommodate various sizes of plant stems. The first sheathe open end 6 and the second sheathe open end 7 are offset from each other around the lateral portion 3. Because the cord sheathe 5 is not connected fully around the lateral portion 3 adjacent to the open end 2, a free portion 9 of the elastic cord 8 is positioned external to the cord sheathe 5 and may be grasped by the user in order to adjust the size of the open end 2.

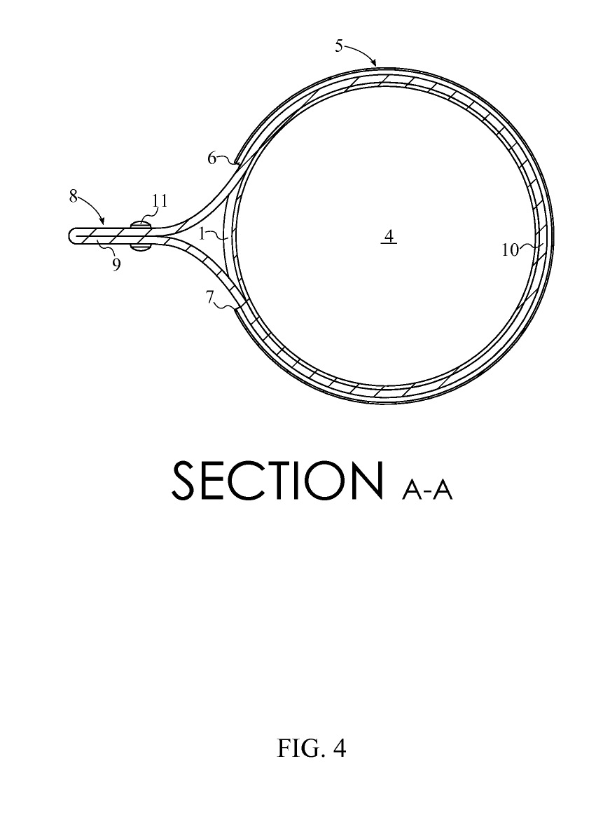

The elastic cord 8 is utilized to tighten the open end 2 of the tubular membrane 1 around the stem 18 of the plant 17 in order to prevent insects and other pests from entering the tubular membrane 1 when the present invention is in place on the plant 17 as shown in FIG. 7. With reference to FIG. 4, the elastic cord 8 comprises a free portion 9 and an adjustable portion 10. The free portion 9 is utilized to adjust the position of the cord clamp 11 on the elastic cord 8 when increasing and decreasing the size of the open end 2 around the stem 18. The length of the free portion 9 increases as the size of the open end 2 is decreased while the length of the free portion 9 decreases as the size of the open end 2 is increased. The adjustable portion 10 is utilized to constrict the open end 2 when decreasing the size of the open end 2 and to loosen the open end 2 when increasing the size of the open end 2. The free portion 9 is located external to the cord sheathe 5, adjacent to the first sheathe open end 6 and the second sheathe open end 7. This allows the user to grasp the free portion 9 when adjusting the size of the open end 2 as the free portion 9 is positioned external to the cord sheathe 5. The adjustable portion 10 is sleeved by the cord sheathe 5 from the first sheathe open end 6 to the second sheathe open end 7. As such, the adjustable portion 10 remains in constant contact with the tubular membrane 1, allowing the adjustable portion 10 to constrict and loosen the open end 2 in order to decrease and increase the size of the open end 2, respectively.

The cord clamp 11 is utilized to fix the elastic cord 8 in place on the tubular membrane 1 when the open end 2 has been sufficiently closed to prevent insects and pests from accessing the interior of the tubular membrane 1. The cord clamp 11 is slidably engaged along the free portion 9, allowing the user to slide the cord clamp 11 along the free portion 9 when adjusting the size of the open end 2. The cord clamp 11 may then be locked in place in order to fix the size of the open end 2 around the stem 18 as shown in FIG. 7. In the preferred embodiment of the present invention, the cord clamp 11 is a toggle cord lock. The cord clamp 11 may be temporarily actuated in order to adjust the position of the cord clamp 11 on the free portion 9 and the corresponding size of the open end 2. When the cord clamp 11 is in the desired position and the size of the open end 2 is as desired, the cord clamp 11 is released in order to lock the cord clamp 11 in place on the free portion 9.

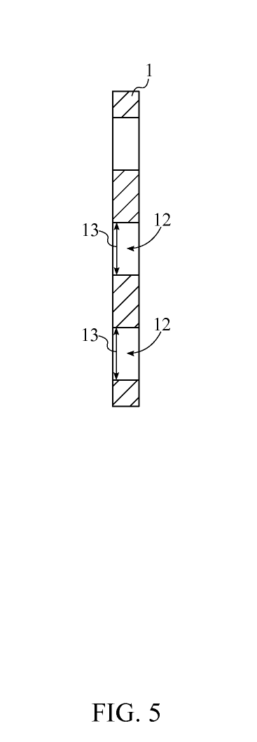

The plurality of pores 12 allows water and air to pass from the exterior environment into the tubular membrane 1. As such, due to the plurality of pores 12, the present invention is a breathable barrier enclosing the potting soil of a plant 17. Furthermore, the plant 17 may be watered without removing the present invention from the container in which the plant 17 is growing. With reference to FIG. 5, the plurality of pores 12 traverses through the tubular membrane 1 liquid and air to freely pass through the tubular membrane 1 through the plurality of pores 12. Furthermore, the plurality of pores 12 is evenly distributed across the tubular membrane 1. This allows liquid and air to pass through the tubular membrane 1 across the entirety of the tubular membrane 1. In the preferred embodiment of the present invention, the optimal diameter 13 for each of the plurality of pores 12 is between 50 and 200 microns in order to allow both liquid (water) and air to pass through the plurality of pores 12.

The present invention provides a means of protecting the root ball of a plant 17 as well as indirectly protecting the entire plant 17 within a plant growing container 14 from insects and other pests that may potentially damage the plant 17. The present invention thus eliminates the need for harmful pesticides and insecticides. In addition to preventing insects and other pests from accessing the root ball of the plant 17, the present invention additionally prevents the growth of weeds in the soil within the plant growing container 14. While serving as a physical barrier between the root ball of the plant 17 and hazards in the exterior environment, the present invention does not hinder any natural biological functions of the plant 17 that the present invention is protecting. Because the present invention is placed over the plant growing container 14 and not the plant 17 itself, the plant 17 is able to grow uninhibited. Moreover, the tubular membrane 1 is breathable, allowing liquid and oxygen to be provided to the plant 17 unhindered. The tubular membrane 1 additionally serves to block sunlight, preventing the soil within the plant growing container 14 from drying out. Furthermore, the present invention does not need to be removed from the plant 17 in order to water the plant 17, eliminating the need to constantly remove and replace the present invention when the user wishes to provide water to the plant 17. The size of the open end 2 is adjustable, allowing the size of the open end 2 to be increased as the plant 17 grows and the stem 18 grows wider.

As shown in FIG. 6, the present invention is primarily intended for use with a plant 17 that has been planted and is growing in a plant growing container 14, such as a flowerpot. A plant growing container 14 comprises a lip 15 and a base 16. The lip 15 is connected around the upper open end of the plant growing container 14, opposite to the base 16. The base 16 may be perforated in order to allow excess water to flow out of the plant growing container 14 when watering the plant 17 within the plant growing container 14. When securing the present invention to the plant growing container 14, the plant growing container 14 is inserted into the tubular membrane 1 from the open end 2. The closed end 4 is positioned onto the base 16 while the lip 15 is positioned adjacent to the open end 2 in order to fully envelop the plant growing container 14 within the tubular membrane 1. The nylon and spandex blended material of the preferred embodiment of the present invention allows the tubular member to be elastically stretched over the plant growing container 14 and allows the present invention to be utilized with a plant growing container 14 of any size. The free portion 9 is then pulled in order to decrease the length of the adjustable portion 10 within the cord sheathe 5. As the length of the adjustable portion 10 is decreased, the elastic cord 8 is tightened around the stem 18 of the plant 17. The elastic cord 8 is tightened until the open end 2 is positioned against and encircling the stem 18 as shown in FIG. 7. This prevents insects and other pests from entering the through the open end 2 and causing damage to the plant 17. Additionally, because the plant growing container 14 is positioned within the tubular membrane 1, weeds and other invasive plant species are unable to grow within the plant growing container 14.

Once the plant growing container 14 is enclosed within the tubular membrane 1, the cord clamp 11 is slid closer to the open end 2 in order to set the length of the adjustable portion 10. The cord clamp 11 is slid up to the first sheathe open end 6 and the second sheathe open end 7, preventing the length of the adjustable portion 10 and the free portion 9 from changing. When the cord clamp 11 is in place, the cord clamp 11 is able to keep the open end 2 positioned against and encircling the stem 18.

The present invention provides an array of benefits to the plant 17 within the plant growing container 14. In addition to protecting the plant 17 from pests and invasive plant species, the present invention allows the user to water the plant 17 through the tubular membrane 1. Water is poured onto the tubular membrane 1 adjacent to the open end 2 in order to allow the water to enter the tubular membrane 1 and the plant growing container 14. The present invention does not need to be removed from the plant growing container 14 prior to watering the plant 17. When water is poured onto the tubular membrane 1, the water traverses through the plurality of pores 12 onto the plant 17. Excess water draining through the perforations of the plant growing container 14 is able to traverse through the plurality of pores 12 and exit the tubular membrane 1. As the plant 17 grows, the cord clamp 11 is slid away from the open end 2, increasing the size of the adjustable portion 10 and loosening the elastic cord 8 around the growing stem 18.

The present invention has applications in addition to a plant that is planted and grown in a plant growing container 14. Within a hydroponic growing system wherein the roots of a plant are floating in a mineral solution or water, the roots of the plant may be enclosed within the tubular membrane 1. The present invention prevents the roots from potentially clogging filters, pumps, and other equipment, while additionally preventing fish from accessing and harming the roots. The present invention may further be utilized in an aeroponic growing system in which a plant is grown without the use of soil or other medium and the plant's roots are left suspended in the air. The roots in this aeroponic growing system may be enclosed within the tubular membrane 1, similar to the hydroponic growing system. Finally, the present invention may be utilized to transport a plant and keep the plant's root ball intact, minimizing the amount of dirt that is left behind after the plant is moved.

Although the present invention has been explained in relation to its preferred embodiment, it is understood that many other possible modifications and variations can be made without departing from the spirit and scope of the present invention as hereinafter claimed.

What is claimed is:

1. A protective horticultural bag comprises:
a tubular membrane;
a cord sheathe;
an elastic cord;
a cord clamp;
a plurality of pores;
the tubular membrane comprises an open end, a lateral portion, and a closed end;
the cord sheathe comprises a first sheathe open end and a second sheathe open end;
the elastic cord comprises a free portion and an adjustable portion;
the plurality of pores traversing through the tubular membrane;
the plurality of pores being evenly distributed across the tubular membrane;
the cord sheathe being externally connected around the lateral portion, adjacent to the open end;
the first sheathe open end and the second sheathe open end being offset from each other around the lateral portion;
the adjustable portion being sleeved by the cord sheathe from the first sheathe open end to the second sheathe open end;
the free portion being located external to the cord sheathe, adjacent to the first sheathe open end and the second sheathe open end; and
the cord clamp being slidably engaged along the free portion.

2. The protective horticultural bag as claimed in claim 1, wherein the tubular membrane is made of a nylon and spandex blended material.

3. The protective horticultural bag as claimed in claim 1, wherein an optimal diameter for each of the plurality of pores is between 50 and 200 microns.

4. The protective horticultural bag as claimed in claim 1, wherein the cord clamp is a toggle cord lock.

5. A method of securing the protective horticultural bag as claimed in claim 1 to a plant growing container, the method comprises the steps of:
providing the plant growing container, wherein the plant growing container comprises a lip and a base;
providing a plant, wherein the plant is planted in the plant growing container;
positioning the closed end onto the base and positioning the lip adjacent to the open end by inserting the plant growing container into the tubular membrane from the open end;
pulling the free portion in order to decrease the length of the adjustable portion and tighten the elastic cord around a stem of the plant;
sliding the cord clamp closer to the open end in order to set the length of the adjustable portion;
pouring water onto the tubular membrane adjacent to the open end; and
sliding the cord clamp away from the open end in order to increase the size of the adjustable portion and loosen the elastic cord around the stem as the plant grows.

6. The method of securing the protective horticultural bag as claimed in claim 5, wherein the water traverses through the plurality of pores onto the plant.

7. The method of securing the protective horticultural bag as claimed in claim 5, wherein the tubular membrane is elastically stretched over the plant growing container.

8. The method of securing the protective horticultural bag as claimed in claim 5, wherein the cord clamp is slid up to the first sheathe open end and the second sheathe open end.

9. A protective horticultural bag comprises:
a tubular membrane;
a cord sheathe;
an elastic cord;
a cord clamp;
a plurality of pores;
the tubular membrane comprises an open end, a lateral portion, and a closed end;
the cord sheathe comprises a first sheathe open end and a second sheathe open end;
the elastic cord comprises a free portion and an adjustable portion;
the tubular membrane being made of a nylon and spandex blended material;
the cord clamp being a toggle cord lock;
the plurality of pores traversing through the tubular membrane;
the plurality of pores being evenly distributed across the tubular membrane;
the cord sheathe being externally connected around the lateral portion, adjacent to the open end;
the first sheathe open end and the second sheathe open end being offset from each other around the lateral portion;
the adjustable portion being sleeved by the cord sheathe from the first sheathe open end to the second sheathe open end;
the free portion being located external to the cord sheathe, adjacent to the first sheathe open end and the second sheathe open end; and
the cord clamp being slidably engaged along the free portion.

10. The protective horticultural bag as claimed in claim 9, wherein an optimal diameter for each of the plurality of pores is between 50 and 140 microns.
